(19) United States
(12) Patent Application Publication
(10) Pub. No.: US 2019/0137040 A1
(43) Pub. Date: May 9, 2019

(54) SYSTEM AND METHOD FOR LIQUID NITROGEN RECYCLING

(71) Applicant: Delta Design, Inc., Poway, CA (US)

(72) Inventor: Jerry Ihor TUSTANIWSKYJ, Mission Viejo, CA (US)

(73) Assignee: Delta Design, Inc., Poway, CA (US)

(21) Appl. No.: 16/184,637

(22) Filed: Nov. 8, 2018

Related U.S. Application Data
(60) Provisional application No. 62/583,274, filed on Nov. 8, 2017.

(51) Int. Cl. F17C 7/04

(52) U.S. Cl. CPC F17C 7/04; F17C 2205/0323; F17C 2227/0135; F17C 2270/0518; F17C 2221/031; F17C 2227/0302; F17C 2221/014

(57) ABSTRACT

A thermal control method and assembly uses an expansion chamber structured to receive liquid nitrogen and expand the liquid to nitrogen gas having a first temperature. The nitrogen gas having the first temperature is provided to a system. A pump is configured to receive the nitrogen gas at a second temperature and a second pressure from the system. The pump is further configured to pump the nitrogen gas at a third temperature and third pressure. A sump is structured to receive the nitrogen gas at the third temperature and the third pressure from the pump, and recirculate at least a portion of the nitrogen gas to the expansion chamber.

### CROSS-REFERENCE TO RELATED APPLICATIONS

This application claims the benefit of and priority to U.S. Provisional Appl. 62/583,274, filed Nov. 8, 2017, the entire disclosure of which is incorporated by reference herein.

### TECHNICAL FIELD

The present disclosure relates generally to a temperature control system and method in which liquid nitrogen is recycled.

### BACKGROUND

Over the last three decades, the semi-conductor industry has witnessed rapid expansion with progress in transistors, micro-electro-mechanical-systems (MEMS) devices and nanotechnology. Volume production of such semi-conductor and MEMS devices has led to the development of new systems for handling and testing such semi-conductor devices. Conventional semi-conductor handling and testing systems are configured to perform various tests on semi-conductor devices including performance under varying temperature conditions (e.g., in the range of −60 degrees Celsius to 200 degrees Celsius).

To achieve the low temperatures for thermal tests, conventional semi-conductor handling and testing systems often include cooling assemblies configured to handle liquid nitrogen and nitrogen gas at sub-zero temperatures. The liquid nitrogen may be expanded to nitrogen gas having a predetermined temperature substantially lower than a temperature to which the semi-conductor devices needs to be cooled. In many conventional systems, the nitrogen gas is vented to the atmosphere, which may lead to increase operation costs, and condensation issues at nitrogen gas exhaust.

### SUMMARY

Embodiments described herein relate generally to systems and methods for managing liquid nitrogen used for cooling applications in testing and handling systems for semi-conductor materials. Particularly, embodiments described herein include systems and methods for providing nitrogen gas at a desired temperature and pressure to a system, and recirculating at least a portion of the used nitrogen gas for reuse.

In a set of embodiments, a cooling assembly comprises an expansion chamber structured to receive liquid nitrogen and expand the liquid to nitrogen gas having a first temperature. The nitrogen gas having the first temperature is provided to a system to be thermally controlled, such as a semiconductor test or handler assembly. A pump is configured to receive the nitrogen gas at a second temperature and a second pressure from the system. The pump is further configured to pump the nitrogen gas at a third temperature and third pressure. A sump is structured to receive the nitrogen gas at the third temperature and the third pressure from the pump, and recirculate at least a portion of the nitrogen gas to the expansion chamber.

In certain embodiments, the cooling assembly is configured to selectably provide a mixture of compressed dry air (CDA) and nitrogen gas at a desired temperature to a contactor in the system to be thermally controlled, and recycle at least a portion of the nitrogen gas.

In certain embodiments, a method for recycling nitrogen in a liquid nitrogen thermal control system includes: providing liquid nitrogen to a chamber; expanding the liquid nitrogen in the chamber to nitrogen gas having a first temperature; providing the nitrogen gas at the first temperature to a system to be thermally controlled; providing the nitrogen gas at a second temperature from the system to be controlled to a pump; pumping the nitrogen gas at a third temperature to an exhaust via a sump; and recirculating at least a portion of the nitrogen gas from the sump to the chamber.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1 is a schematic block diagram of a cooling assembly, according to an embodiment.

FIG. 2 is a schematic block diagram of a cooling assembly, according to another embodiment.

FIG. 3 is a schematic block diagram of a cooling assembly, according to yet another embodiment.

FIG. 4 is a schematic flow diagram of a method for handling liquid nitrogen, according to an embodiment.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to systems and methods for managing liquid nitrogen used for cooling applications in testing and handling systems for semi-conductor materials. Particularly, embodiments described herein include systems and methods for providing nitrogen at a desired temperature and pressure to a system, and recirculating at least a portion of the used nitrogen gas for reuse. It should be understood that while the detailed description below includes exemplary values of operational parameters, such as particular temperatures and pressures, other values may be used depending on the particular application.

Conventional semi-conductor handling and testing systems are configured to perform various tests on semi-conductor devices including performance under varying temperature conditions (e.g., in the range of −60 degrees Celsius to 200 degrees Celsius). To achieve the low temperatures for thermal tests, conventional semi-conductor handling and testing systems often include cooling assemblies configured to handle liquid nitrogen and nitrogen gas at sub-zero temperatures. The liquid nitrogen may be expanded to nitrogen gas having a predetermined temperature substantially lower than a temperature to which the semi-conductor devices needs to be cooled. In many conventional systems, the nitrogen gas is vented to the atmosphere, which may lead to increase operation costs, and condensation issues at nitrogen gas exhaust.

Various embodiments of the cooling assemblies described herein may provide benefits including, for example: (1) recycling at least a portion of nitrogen used for cooling a portion of a system so as to reduce condensation issues and waste; (2) reducing a nitrogen purge flow rate and heating power used for the purge flow; (3) reducing or eliminating the use of compressed dry air (CDA); and (4) providing ease of use and reducing cost.

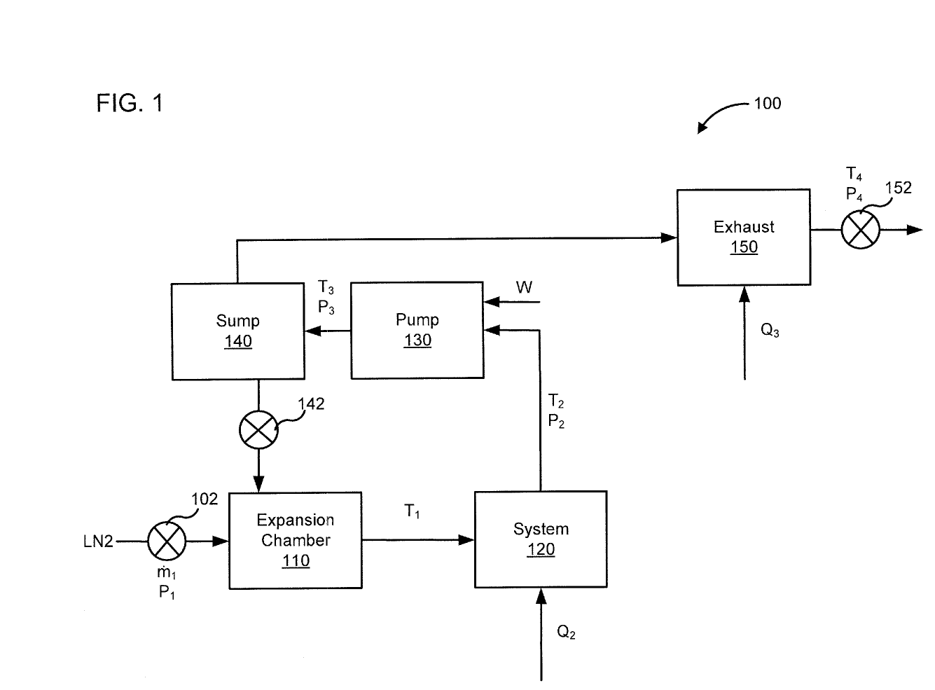

FIG. 1 is a schematic illustration of a cooling assembly 100 configured to handle liquid nitrogen, according to an embodiment. The cooling assembly 100 comprises an expansion chamber 110, a pump 130, a sump 140 and an exhaust 150.

As shown in FIG. 1, a first valve 102 is positioned upstream of the expansion chamber 110 and used to control a mass flow rate \dot{m}₁ of liquid nitrogen into the expansion chamber 110. The liquid nitrogen may be at a first pressure P₁. The first valve 102 may include a cryogenic solenoid valve, a manual valve, an automatic valve, a vented ball valve, any other suitable valve or a combination thereof. In some embodiments, the mass flow rate \dot{m}₁ may be, for example, in the range of 0.4-0.6 liters per minutes (e.g., 0.4, 0.41, 0.42, 0.43, 0.44, 0.45, 0.46, 0.47, 0.48, 0.49 or 0.5 liters per minute inclusive of all other ranges and values therebetween). A temperature of the liquid nitrogen may be less than −180 degrees Celsius. The first pressure P₁ of the liquid nitrogen may be a saturation pressure of liquid nitrogen in the range of 1-4 bar (e.g., 1.0, 1.2. 1.4, 1.6, 1.8, 2.0, 2.2, 2.4, 2.6, 2.8, 3.0, 3.2, 3.4, 3.6, 3.8 or 4.0 bar inclusive of all ranges and values therebetween). Of course other flow rates and temperatures, and pressures may be utilized depending on the application.

The first valve 102 may be selectively opened (e.g., via a controller (not shown)) to deliver the liquid nitrogen at the mass flow rate \dot{m}₁ and the first pressure P₁ to the expansion chamber 110. The expansion chamber 110 may be configured to allow the liquid nitrogen to evaporate to produce nitrogen gas, and may include, for example by adding heat directly via a heater, and/or by mixing with a warmer gas. In some embodiments, the expansion chamber 110 may be configured to reduce a pressure of the liquid nitrogen so as to boil the nitrogen gas and increase its temperature. In particular embodiments, the expansion chamber 110 is structured to receive a recycled nitrogen gas from the sump 140 so as to increase a temperature of the liquid nitrogen and expand to the nitrogen gas. Conventional systems often mix warmer CDA with the liquid nitrogen so as to expand the liquid nitrogen to nitrogen gas. The cooling assembly 100 advantageously uses recycled nitrogen gas instead of or in addition to CDA. This reduces an amount of liquid nitrogen used by the cooling assembly 100, as well as an amount of nitrogen gas vented to the environment. Furthermore, the recycled nitrogen gas generally has a lower temperature than CDA, therefore a ratio of the liquid nitrogen to the recycled nitrogen gas may also be lower, as less heat is removed. The expansion chamber 110 generates nitrogen gas at a first temperature T₁, for example in the range of −170 to −190 degrees Celsius (e.g., −170, −172, −174, −176, −178, −180, −182, −184, −186, −188 or −190 degrees Celsius inclusive of all ranges and values therebetween). The nitrogen gas is communicated to a system 120, for example a semi-conductor handling and/or testing system, which may include, for example a contactor which engages the semi-conductor devices.

The system 120 may use the nitrogen gas provided by the expansion chamber 110 in a cooling operation, for example to cool the contactor to a predetermined temperature. In some embodiments, a second power Q₂ used by the system 120 may be in the range of 4-6 kW (e.g., 4.0, 4.2, 4.4, 4.6, 4.8, 5.0, 5.2, 5.4, 5.6, 5.8 or 6.0 kW inclusive of all ranges and values therebetween), and may result in the heating of the nitrogen gas to a second temperature T₂, for example in the range of −70 to −90 degrees Celsius (e.g., −70, −72, −74, −76, −78, −80, −82, −84, −86, −88 or −90 degrees Celsius inclusive of all ranges and values therebetween). Furthermore, a pressure of the nitrogen gas may be reduced to a second pressure P₂, for example in the range of 0.5 bar to 1.5 bar (e.g., 0.5, 0.6, 0.7, 0.8, 0.9, 1.0, 1.1, 1.2, 1.3, 1.4 or 1.5 bar inclusive of all ranges and values therebetween). In particular embodiments, the second pressure P₂ may be 1 bar. These values are only examples; others may be utilized depending on the application.

The heated and expanded nitrogen gas at the second temperature T₂ and second pressure P₂ is communicated to the pump 130. The pump 130 is configured to compress the gas and communicate the gas at a third temperature T₃ and a third pressure P₃ to the sump 140. In some embodiments, the third temperature T₃ may be in the range of −50 to −60 degrees Celsius (e.g., −50, −52, −54, −56, −58 or −60 degrees Celsius inclusive of all ranges and values therebetween), and the third pressure P₃ may be in the range of 1.0-3 bar (e.g., 1.0, 1.2, 1.4, 1.6, 1.8, 2.0, 2.2, 2.4, 2.6, 2.8, 3.0 bar inclusive of all ranges and values therebetween). In various embodiments, the pump 130 may be operated such that the second pressure P₂ of the nitrogen gas at the inlet of the pump 130 remains at 1 bar. A power W used by the pump 130 for compressing the nitrogen gas may be in a range of 1.2 to 1.6 kW (e.g., 1.1, 1.2, 1.3, 1.4, 1.5 or 1.6 kW inclusive of all ranges and values therebetween). Other values may be utilized depending on the application.

The sump 140 is structured to recirculate at least a portion of the nitrogen gas received from the pump 130 to the expansion chamber 110. In other words, the sump 140 recycles at least a portion of the nitrogen gas back to the expansion chamber 110 so that it may be reused for the cooling operation in the system 120. A second valve 142 may be positioned between the sump 140 and the expansion chamber 110 so as to control a flow rate of the portion of the recycled nitrogen gas to the expansion chamber 110.

In various embodiments, the second valve 142 may include a flow control valve for controlling a flow of recycled nitrogen gas to the expansion chamber 110, for example to enable mixing of the recycled nitrogen gas with the liquid nitrogen at a desired ratio such that the expansion chamber 110 generates the nitrogen gas at the first temperature T₁. In conventional systems, nitrogen gas may be vented to atmosphere which causes condensation and maintenance issues. The cooling assembly 100 eliminates such issues by recycling the portion of the nitrogen gas vented from the sump 140 back to the expansion chamber 110. Furthermore, the recycled portion of the nitrogen gas is at the higher third temperature T₃ and may facilitate expansion of the liquid nitrogen to nitrogen gas in the expansion chamber 110 to the first temperature T₁.

The exhaust 150 is positioned downstream of the sump 140. The exhaust 150 receives the remaining portion of the nitrogen gas not recycled to the expansion chamber 110, and expands the nitrogen gas to fourth temperature T₄ and fourth pressure P₄. For example, the exhaust 150 may include a heater for heating the remaining portion of the nitrogen gas to the fourth temperature T₄ and the fourth pressure P₄. In various embodiments, the exhaust 150 may use a third power Q₃, for example, in the range of 2-2.5 kW (e.g., 2.0, 2.1, 2.2, 2.3, 2.4 or 2.5 kW inclusive of all ranges and values therebetween). Furthermore, the fourth temperature T₄ may be, for example, in the range of 15-25 degrees Celsius (e.g., 15, 17, 19, 21, 23 or 25 degrees Celsius inclusive of all ranges and values therebetween), and the fourth pressure P₄ may be, for example, in the range of 1-2 bar (e.g., 1.0, 1.1, 1.2, 1.3, 1.4, 1.5, 1.6, 1.7, 1.8, 1.9 or 2.0 bar inclusive of all ranges and values therebetween). The exhaust 150 may vent the nitrogen gas to atmosphere. A third valve 152 may include a pressure release valve structured to vent used nitrogen gas to atmosphere in response to a sump pressure in the sump (e.g., the fourth pressure P₄) from increasing beyond a predetermined pressure threshold. In this manner, the third valve 152 may maintain the sump at a predetermined sump pressure so as to facilitate efficient mixing of the recycled nitrogen gas with the liquid nitrogen. While the third valve 152 is illustrated in FIG. 1 as being downstream of the exhaust 150, it may preferably be disposed upstream of the exhaust.

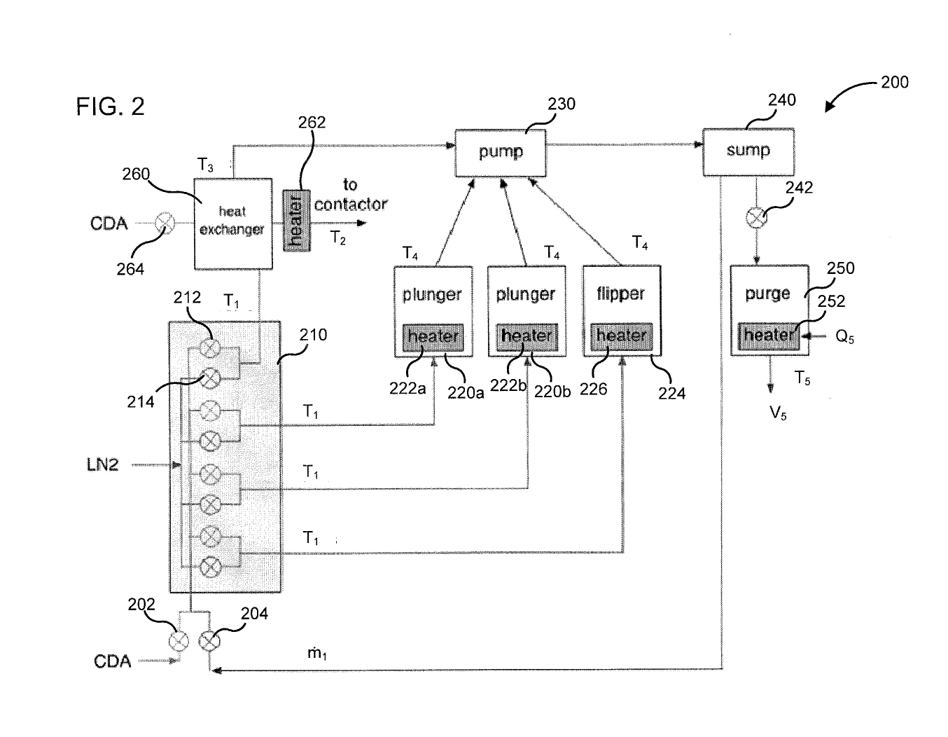

FIG. 2 is a schematic block diagram of a cooling assembly 200 for handling liquid nitrogen, according to another embodiment. The cooling assembly 200 is configured to provide a mixture of compressed dry air (CDA) and nitrogen gas at a desired temperature to a contactor (e.g., a contactor included in the system 120), and recycle at least a portion of the nitrogen gas. The cooling assembly 200 comprises a mixing chamber 210, a first plunger 220a, a second plunger 220b, a flipper 224, a pump 230, a sump 240, a purge chamber 250, and a heat exchanger 260.

A first upstream valve 202 is positioned upstream of the mixing chamber 210 and structured to control a flow rate of a first CDA stream into the mixing chamber 210. A second upstream valve 204 is also positioned upstream of the mixing chamber 210 and structured to control a flow rate mi of a recycled nitrogen gas stream received from the sump 240 into the mixing chamber 210. The flow rate \dot{m}₁ of the recycled nitrogen gas maybe in the range of 12-15 kg per hour (e.g., 12.0, 12.5, 13.0, 13.5, 14.0, 14.5 or 15.0 kg per hour inclusive of all ranges and values therebetween). The first CDA stream may be mixed with the recycled nitrogen gas stream so as to form a first mixture communicated into the mixing chamber 210. In particular embodiments, a flow rate of the first CDA stream into the mixing chamber 210 may be about zero, such that only the recycled nitrogen gas stream is communicated into the mixing chamber 210. In such embodiments, the first upstream valve 202 may not be included in the cooling assembly 200.

The mixing chamber 210 comprises a set of first valves 212 and a set of second valves 214. In this example, the first mixture delivered into the mixing chamber 210 is divided into four first mixture streams. A corresponding first valve 212 of the set of first valves 212 is used to control a flow rate of a corresponding first mixture stream. The first mixture may only include the recycled nitrogen gas received from the sump 240, as previously described herein. Furthermore, the liquid nitrogen is communicated into the mixing chamber 210 and divided into four liquid nitrogen. A corresponding second valve 214 of the set of second valves 214 may be used to control a flow rate of the corresponding liquid nitrogen stream. A flow rate of the liquid nitrogen into the mixing chamber 210 may be, for example, in the range of 12-15 kg per hour (e.g., 12.0, 12.5, 13.0, 13.5, 14.0, 14.5 or 18.0 kg per hour inclusive of all ranges and values therebetween), for example, in embodiments in which only the recycled nitrogen gas is provided to the mixing chamber 210. In contrast, if only the first CDA stream is used in the mixing chamber 210, the flow rate of the liquid nitrogen may be, for example, greater than 17 kg per hour. Of course, these values are only examples; others may be utilized depending on the application.

Each stream of liquid nitrogen mixes with the corresponding stream of the first mixture (e.g., the recycled nitrogen gas), so as to generate a first stream, a second stream, a third stream and a fourth stream of nitrogen gas, each having a first temperature T₁ in the range of, for example, −155 to −175 degrees Celsius (e.g., −155, −160, −165, −170 or −175 degrees Celsius inclusive of all ranges and values therebetween). In other exemplary embodiments, the first temperature may range from −110 degrees Celsius to −150 degrees Celsius (e.g., −110, −115, −120, −125, −130, −135, −140, −145 or −150 degrees Celsius inclusive of all ranges and values therebetween). While FIG. 2 shows each of the first stream, the second stream, the third stream and the fourth stream, having the same temperature T₁, in various embodiments, each stream may have a different temperature. The first stream of nitrogen gas at the first temperature is communicated to the heat exchanger 260. A second CDA stream may also be communicated into the heat exchanger 260. A third valve 264 may be positioned upstream of the heat exchanger 260 and configured to control a flow rate of second CDA stream into the heat exchanger 260.

The heat exchanger 260 also includes a first heater 262 positioned therein or downstream thereof. In some embodiments, the heat exchanger 260 may include a plate heat exchanger. The second CDA stream may exchange heat with the first stream of nitrogen gas (e.g., mix with the first stream of nitrogen gas to produce a second mixture upstream of the heat exchanger 260 or therein), and generate a contactor nitrogen gas stream which after passing through the first heater 262, has a second temperature T₂, for example, in the range of −70 to −90 degrees Celsius (e.g., −70, −75, −80, −85 or −90 degrees Celsius inclusive of all ranges and values therebetween). The contactor nitrogen gas stream is then communicated to the contactor for use in a cooling operation.

Any remaining portion of the first stream of nitrogen gas and/or the second mixture, from the heat exchanger and/or recirculated back from the contactor after use in the cooling operation is communicated as a used nitrogen gas stream having a third temperature T₃ towards the pump 230. The third temperature T₃ may be, for example, in the range of about 15-20 degrees Celsius (e.g., 15, 16, 17, 18, 19 or 20 degrees Celsius inclusive of all ranges and values therebetween). The used nitrogen gas stream is communicated to the pump 230. In other embodiments, a contactor temperature for a particular application may be in the range of −60 degrees Celsius to 0 degrees Celsius. In embodiments, the third temperature T₃ of the used nitrogen gas may be, for example, in the range of −60 degrees Celsius to 0 degrees Celsius (e.g., −60, −50, −40, −30, −20, −10 or 0 degrees Celsius inclusive of all ranges and values therebetween). Furthermore, the second temperature T₂ may also be higher in such embodiments, for example in the range of −60 degrees Celsius to 0 degrees Celsius (e.g., −60, −50, −40, −30, −20, −10 or 0 degrees Celsius inclusive of all ranges and values therebetween).

As previously described, the cooling assembly 200 also includes the first plunger 220a, the second plunger 220b, and the flipper 224. The first plunger 220a may include a first plunger heater 222a, the second plunger 220b may include a second plunger heater 222b and the flipper 224 may include a flipper heater 226, each of which heaters may optionally be used or omitted. The first plunger 220a, the second plunger 220b and the flipper 224 receive the second stream, the third stream and the fourth stream of nitrogen gas, respectively from the mixing chamber 210, and optionally heat the second stream, the third stream and the fourth stream to a fourth temperature T₄. In various embodiments, the fourth temperature T₄ may be, for example, in the range of −50 to −80 degrees Celsius (e.g., −50, −55, −60, −65, −70, −75 or −80 degrees Celsius inclusive of all ranges and values therebetween). Each of the second stream, third stream, and the fourth stream of nitrogen gas are communicated to the pump 230. While FIG. 2 shows each of the second stream, third stream and fourth stream, having the same temperature T₄, in various embodiments, each stream may have a different temperature.

The pump 230 combines the heated second, third and fourth streams of nitrogen gas with the used nitrogen gas stream received from the heat exchanger 260 so as to generate an exhaust nitrogen gas stream pumped to the sump 240. The sump 240 is structured to recirculate at least a portion of the exhaust nitrogen gas stream towards the mixing chamber 210, i.e., generate the recycled nitrogen gas stream recirculated to the mixing chamber 210. In particular embodiments as previously described, the sump 240 generates sufficient mass flow rate \dot{m}₁ of the recycled nitrogen gas stream so as to eliminate the use of the first CDA stream in the mixing chamber 210.

The remaining portion of the exhaust nitrogen gas stream is communicated from the sump 240 to a purge chamber 250. A fourth valve 242 may be positioned upstream of the purge chamber 250 to provide pressure relief to the sump by venting the remaining exhaust nitrogen gas stream portion into the purge chamber 250. The purge chamber 250 may include a purge chamber heater 252 configured to heat the remaining exhaust nitrogen gas stream portion to a fifth temperature T₅ close to room temperature, for example in the range of 10-25 degrees Celsius (e.g., 10, 15, 20 or 25 degrees Celsius inclusive of all ranges and values therebetween).

In some embodiments, the volume flow rate V₅ of the remaining exhaust nitrogen gas stream portion after extracting the recycled nitrogen gas stream is, for example, in the range of 11-14 cubic meter per hour (e.g., 11.0, 11.5, 12.0, 12.5, 13.0, 13.5 or 14.0 inclusive of all ranges and values therebetween). This may be significantly lower compared to when the nitrogen gas is not recycled from the sump 240 (e.g., greater than 30 cubic meter per hour). Furthermore, a purge chamber heater power Q₅ used by the purge chamber heater 252 when at least a portion of the exhaust nitrogen gas stream is recycled may be, for example, in the range 0.5-1 kW (e.g., 0.5, 0.6, 0.7, 0.8, 0.9 or 1 kW inclusive of all range and values therebetween), which may be significantly lower than the purge chamber heater power Q₅ used by the purge chamber heater 252 when all the exhaust nitrogen gas is vented (e.g., greater than 2 kW).

In this manner, recycling at least a portion of the exhaust nitrogen gas may reduce or eliminate use of the CDA in the mixing chamber 210 by replacing the first CDA stream partially, or completely with the recycled nitrogen gas stream. Furthermore, an exhaust nitrogen gas volume flow rate as well as the purge chamber heater power Q₅ may also be decreased. Furthermore, any or all of the heaters included in the cooling assembly 200, for example the first heater 262, the first plunger heater 222a, the second plunger heater 222b, the flipper heater 226 and/or the purge chamber heater 252 may be optional, and the temperatures of the nitrogen gas at various locations in the cooling assembly 200 may be effectively controlled via the valves 212, 214, 264 and/or 242.

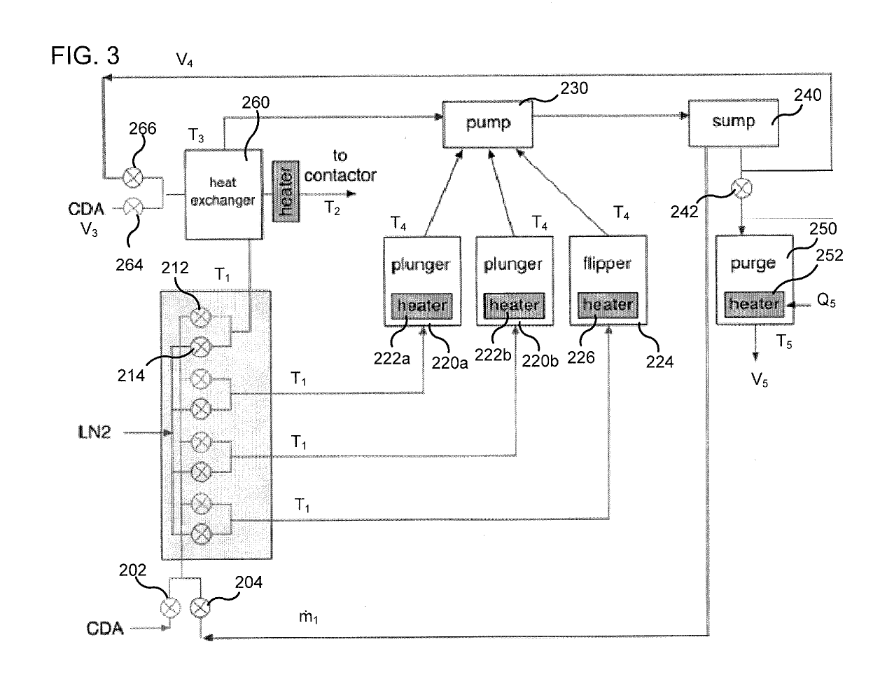

FIG. 3 is a schematic illustration of a cooling assembly 300 for handling liquid nitrogen, according to yet another embodiment. The cooling assembly 300 may comprise the mixing chamber 210, the first plunger 220a, the second plunger 220b, the flipper 224, the pump 230, the sump 240, the purge chamber 250, and the heat exchanger 260. The cooling assembly 300 is substantially similar to the cooling assembly 200, with the following differences.

As previously described with respect to the cooling assembly 200, the sump 240 recirculates a first portion of the exhaust nitrogen gas stream as the recycled nitrogen gas stream to the mixing chamber 210 such that the flow rate of the first CDA stream may be reduced or completely eliminated. In the cooling assembly 300, the sump 240 is structured to further recirculate a second portion of the exhaust nitrogen gas to the heat exchanger 260. A fifth valve 266 may be positioned between the sump 240 and the heat exchanger 260 and configured to control a volume flow rate of the second portion of the exhaust nitrogen gas into the heat exchanger 260.

In the cooling assembly 200, the second CDA stream communicated via the valve 264 into the heat exchanger 260 may have a second CDA stream flow rate V₃ in the range of, for example, 5-6 cubic meter per hour (e.g., 5.1, 5.2, 5.3, 5.4, 5.5, 5.6, 5.7, 5.8, 5.9 or 6 cubic meter per hour). In the cooling assembly 300, the second stream of CDA is partially or completely replaced by the second portion of the exhaust gas stream. For example, the second portion of the exhaust gas stream may have a second exhaust gas stream volume flow rate V₄ in the range of 5-6 cubic meter per hour (e.g., 5.1, 5.2, 5.3, 5.4, 5.5, 5.6, 5.7, 5.8, 5.9 or 6 cubic meter per hour). In this manner, the cooling assembly 300 may use recycled nitrogen gas in the mixing chamber 210 as well as the heat exchanger 260 replacing the first CDA stream and the second CDA stream such that the cooling assembly 300 may not use any CDA.

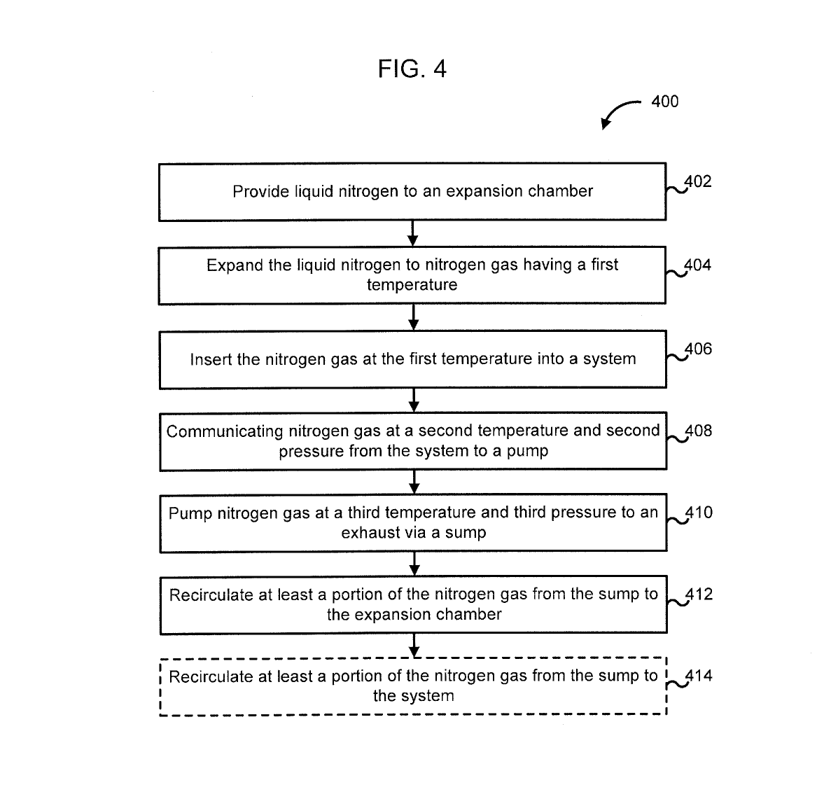

FIG. 4 is a schematic flow diagram of an example method 400 for recycling nitrogen in a liquid nitrogen handling assembly. The method 400 may be used with any assembly for handling liquid nitrogen, for example the cooling assembly 100, 200, 300. The method 400 comprises providing liquid nitrogen to an expansion chamber, at 402. For example, the liquid nitrogen is provided to the expansion chamber 110 or the mixing chamber 210.

The liquid nitrogen is expanded to a nitrogen gas having a first temperature, at 404. For example, the liquid nitrogen is expanded to the nitrogen gas in the expansion chamber 110, or in the mixing chamber 210 via mixing with the first CDA stream and/or the recycled nitrogen gas stream. The first temperature of the nitrogen gas may be in the range of, for example, −170 to −190 degrees Celsius (e.g., −170, −172, −174, −176, −178, −180, −182, −184, −186, −188 or −190 degrees Celsius inclusive of all ranges and values therebetween). The nitrogen gas is inserted into a system, at 406. For example, the nitrogen gas is inserted into the system 120, or the first stream of nitrogen gas is inserted into the heat exchanger 260.

The nitrogen gas is communicated at a second temperature and second pressure to a pump, at 408. For example, system 120 may produce the nitrogen gas at the second temperature T₂, for example, in the range of −70 to −90 degrees Celsius (e.g., −70, −72, −74, −76, −78, −80, −82, −84, −86, −88 or −90 degrees Celsius inclusive of all ranges and values therebetween), and the second pressure P₂, for example, in the range of 0.5 bar to 1.5 bar (e.g., 0.5, 0.6, 0.7, 0.8, 0.9, 1.0, 1.1, 1.2, 1.3, 1.4 or 1.5 bar inclusive of all ranges and values therebetween), which is communicated to the pump 130. In particular embodiments, the second pressure P₂ may be, for example, 1 bar. In other embodiments, the heat exchanger 260, the first plunger 220a, the second plunger 220b and the flipper 224 communicate the nitrogen gas at the second temperature and the second pressure to the pump 230.

The nitrogen gas is pumped at a third pressure and third temperature to an exhaust via a sump, at 410. For example, the pump 130 may pump the nitrogen gas at the third temperature T₃ in the range of −50 to −60 degrees Celsius (e.g., −50, −52, −54, −56, −58 or −60 degrees Celsius inclusive of all ranges and values therebetween), and the third pressure P₃ in the range of 1.0-3 bar (e.g., 1.0, 1.2, 1.4, 1.6, 1.8, 2.0, 2.2, 2.4, 2.6, 2.8 or 3.0 bar inclusive of all ranges and values therebetween) to the exhaust 150 via the sump 140. In other embodiments, the pump 230 may pump the used nitrogen gas stream received from the heat exchanger 260 to the purge chamber 250 via the sump 240.

At least a portion of the nitrogen gas is recirculated from the sump to the expansion chamber, at 412. For example, the at least a portion of the nitrogen gas is recirculated from the sump 140 to the expansion chamber 110, or the first portion of the exhaust nitrogen gas stream is recirculated via the sump 240 as the recycled nitrogen gas stream to the mixing chamber 210. In some embodiments, at least a portion of the nitrogen gas is recirculated from the sump to the system, at 414. For example, a second portion of the exhaust gas stream may be recirculated from the sump 240 to the heat exchanger 260.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements; values of parameters, mounting arrangements; use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes, and omissions may also be made in the design, operating conditions, and arrangement of the various exemplary embodiments without departing from the scope of the present application.

While this specification contains many specific implementation details, these should not be construed as limitations on the scope of any embodiments or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A temperature control assembly, comprising:
a chamber configured to receive liquid nitrogen and expand the liquid nitrogen to nitrogen gas having a first temperature, the chamber having an outlet to provide the nitrogen gas having the first temperature to a system to be temperature controlled;
a pump configured to receive the nitrogen gas at a second temperature and a second pressure from the system, the pump being further configured to pump the nitrogen gas at a third temperature and third pressure; and
a sump configured to receive the nitrogen gas at the third temperature and the third pressure from the pump, and recirculate at least a portion of the nitrogen gas to the expansion chamber.

2. The temperature control assembly of claim 1, wherein the system is a semiconductor test or handling system.

3. The temperature control assembly of claim 1, further comprising a first valve controllable to provide the liquid nitrogen to the chamber at a selected flow rate.

4. The temperature control assembly of claim 1, further comprising a second valve controllable to provide recirculated nitrogen gas to the chamber to be mixed with the liquid nitrogen in the expansion chamber at a selected ratio.

5. The temperature control assembly of claim 1, further comprising an exhaust that receives a remaining portion of nitrogen gas not recirculated to the chamber from the sump.

6. The temperature control assembly of claim 5, further comprising a pressure release valve controlling flow of the remaining portion of nitrogen gas from the sump to the exhaust.

7. The temperature control assembly of claim 1, wherein the chamber is configured to selectably receive compressed dry air (CDA) and mix the CDA with the expanded nitrogen and supply the mixture of CDA and nitrogen gas at the first temperature to the system to be temperature controlled.

8. The temperature control assembly of claim 7, further comprising:
a CDA inlet valve controlling flow of CDA to the chamber; and
a recirculated nitrogen control valve disposed between the sump and the chamber, to control flow of recirculated nitrogen from the sump to the chamber.

9. The temperature control assembly of claim 8, further comprising:
at least one plunger and flipper disposed between the chamber and the pump, each of which is configured to receive a stream of the gas at the first temperature and supply each stream to the pump at a fourth temperature.

10. The temperature control assembly of claim 9, wherein the at least one plunger and flipper are provided with a heater controllable to maintain the streams to the sump at the disposed between the chamber and the pump, each of which is configured to receive a stream of the gas at the first temperature and supply each stream to the pump at the fourth temperature.

11. The temperature control assembly of claim 8, further comprising a heat exchanger disposed between the chamber and the pump, the heat exchanger configured to provide the nitrogen gas to the system at a controllable temperature.

12. The temperature control assembly of claim 8, wherein an additional portion of the nitrogen gas is recirculated from the sump to the heat exchange to be mixed into the stream received from the chamber and supplied to the system.

13. The temperature control assembly of claim 12, further comprising a second supply of CDA selectably provided to the heat exchanger to be mixed with the additional portion of recirculated nitrogen gas from the sump.

14. A method for recycling nitrogen in a liquid nitrogen thermal control system, comprising:
providing liquid nitrogen to a chamber;
expanding the liquid nitrogen in the chamber to nitrogen gas having a first temperature;
providing the nitrogen gas at the first temperature to a system to be thermally controlled;
providing the nitrogen gas at a second temperature from the system to be controlled to a pump;
pumping the nitrogen gas at a third temperature to an exhaust via a sump;
recirculating at least a portion of the nitrogen gas from the sump to the chamber.

15. The method of claim 14 further comprising recirculating at least a portion of the nitrogen gas from the sump to the system to be thermally controlled.

16. The method of claim 1, wherein the system is a semiconductor test or handling system.
